(19) United States
(12) Patent Application Publication
(10) Pub. No.: US 2017/0359969 A1
(43) Pub. Date: Dec. 21, 2017

(54) Portable Suspended Trellis and Planter System

(71) Applicant: Jacob Slevkoff, Fresno, CA (US)

(72) Inventor: Jacob Slevkoff, Fresno, CA (US)

(21) Appl. No.: 13/310,750

(22) Filed: Dec. 3, 2011

(51) Int. Cl. A01G 17/06; A01G 9/12

(52) U.S. Cl. CPC A01G 17/06; A01G 9/12; A01G 2017/065

(57) ABSTRACT

A trellis and planter system comprising an upper support member that is suspended below a support surface, a lower support member in spaced apart relation to and positioned below the upper support member, a trellis disposed between and interconnecting the upper and lower support members and a planter suspended below the lower support member. Preferably, each of the upper and lower support members and the planter are elongated and the trellis is substantially flat. Support devices engage and suspend the upper support member, and therefore the system, in an easily removable manner so the system and plants can be moved without harm to the plants. Planter support devices position the planter below the lower support member such that the plants grow upwardly and are supported by the trellis. Water can be delivered to the upper support member so as to drip or spray onto the plants.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

### A. Field of the Invention

The field of the present invention relates generally to hanging planter systems that are used to grow plants. More specifically, the present invention relates to such planter systems that are configured to suspend a planter below a structure and which comprise a trellis that beneficially supports one or more upwardly growing plants, such as vines and the like. Even more particularly, the present invention relates to such planter systems that are portable.

### B. Background

Gardening is an activity that is enjoyed by many people throughout the world. One popular type of gardening is commonly referred to as container gardening, which is the growing of plants in planters, plant pots and other types of containers. Container gardening is particularly popular for persons who do not have access to an area of land or other space for planting an outdoor garden and for persons who desire to grow plants in the deck, patio or balcony areas of a home, apartment or office. As well known by gardeners and other plant growers, many types of plants can be beneficially grown in a container, including flowering plants for decorative purposes and vegetable or fruit bearing plants to produce vegetables or fruit for consumption. One feature of container gardening is that the plant and its growing medium, typically soil, are placed together in the same container, with the plant growing from the growing medium. As a result, a benefit of most container growing systems is that the containers and the plant or plants growing therein are at least somewhat portable. One exception to the portability of container growing systems are the very large generally immovable containers which are occasionally utilized in container gardening.

Many gardeners and others enjoy growing vine plants for decorative and/or the vegetables or fruit that these types of plants produce. Although many of these plants can be grown in unsupported manner, such that the plants grow generally downward, most vine plants benefit by being grown next to a support structure, such as a trellis or the like, on which the vine can grow in a generally upward direction so as to expose more of the plant to sun and air. Most often, the trellis or other support structure is fixedly mounted in the ground or attached to a fence, wall or other permanent or at least semi-permanent structure so the trellis can allow the vines to grow upward while supporting the weight of the plant and any vegetables or fruit that are produced by the plant. While vine type plants are most commonly grown in the ground, generally immediately adjacent to the trellis, vines can be grown from a planter, plant pot or other container in a manner that allows the plant to grow upward over the trellis. In this grown-in-the-ground configuration, neither the container nor the vine plant are portable.

As well known, vine plants are also grown in containers, such as planters, plant pots and the like in a manner that generally allows the container and plant to be at least somewhat portable. In one configuration, the container is configured to be suspended below a beam, ceiling or other support structure with the vines of the plant, including the flowers, vegetables or fruit thereof, allowed to grow over the container and downward toward the ground, floor or other surface above which the container is suspended to produce a hanging vine effect. In fact, it is generally well known that many people hang plant pots indoors or outdoors, such as on a patio or balcony, with a vine type plant growing in the plant pot and hanging down. In another configuration, the container has a trellis attached to, mounted in or otherwise associated therewith such that the vine plant can grow generally upward from the container and across the trellis. Typically, this type of plant growing system is configured for use with the container resting on the floor, deck, patio, ground or other surface. It is known, however, to suspend such a container/trellis system from a surface, such as a ceiling, roof or beam, with the plant being allowed to grow upward from the container on the trellis. The trellis portion of this type of system is not intended to support the vine in a wide, spread out manner, such as is common for fixed trellises.

Plant growing systems comprising a plant pot and a trellis attached to or otherwise associated with the plant pot are known in the prior art. For instance, U.S. Pat. No. 425,745 to Brown and U.S. Pat. No. 4,631,861 to Wuthrich disclose plant growing systems that have a trellis structure that clips onto or otherwise attaches to or near the upper edge of a plant pot. The trellises disclosed in these patents are configured in a generally cylindrical or conical shape with support posts that are connected by circumferentially disposed rings. Neither system describes the plant pot as being suspended from a ceiling, beam or other structure. U.S. Pat. No. 6,370,820 to Moss discloses a plant growing system comprising a planter having a water reservoir, a vertically disposed pole extending upward from at or near the center of the planter, a pole cap at the top of the pole and a plurality of strings attached to the pole cap and extending to the outer walls of the planter to form a cylindrical or conical, depending on the size of the pole cap relative to planter, trellis that supports vine plants above the planter. The system also does not disclose that it is known to support the planter and trellis thereof above the floor, ground or other surface. U.S. Pat. No. 7,891,135 to Laycock discloses a framed box-like planter casing configured to be supported from a wall, window or other partition with one or more plant pots positioned therein that have plants growing therefrom. The planter can also have integrated sprinklers and/or drip irrigation bubblers associated therewith for ease of watering the plants. Although the planter casing can be suspended from a wall, window or other partition, this plant growing systems does not show that it is known to suspend an individual plant container and trellis from a ceiling, beam or other structure so the plant will grow on the trellis above the floor, ground or other surface.

What is needed, therefore, is an improved plant growing system that allows a vine type of plant to beneficially grow across a trellis associated with a planter or other container that is suspended from a ceiling, roof, beam or other structure. Such a system should be configured with a planter or other container that contains the plant growing medium from which a vine type of plant grows and a trellis on which the plant can expand across to improve the growing thereof for ornamental and/or vegetable or fruit producing benefits. The improved plant growing system should be configured to be portable so the user thereof can move the planter, trellis and plant, with the plant growing in the planter and across the trellis, from one location to another. Preferably, the plant growing system should be adaptable for incorporation of various plant watering components to allow the user to easily and effectively provide water to the plant.

### SUMMARY OF THE INVENTION

The portable suspended trellis and planter system of the present invention solves the problems and provides the benefits identified above. That is to say, the present invention discloses a new and improved plant growing system that allows the user to suspend a planter and a trellis associated therewith below a ceiling, roof, beam or other overhead structure in a manner that allows the plant to grow upward across the trellis. The planter of the present system contains the soil or other plant growing medium from which the plant grows and the trellis supports the upper portions of the plant as it expands across the trellis to help it grow and provide the desired ornamental and/or crop producing benefits. The suspended trellis and planter system of the present invention is self-contained, structurally, such that the system is easily and completely portable, allowing the user thereof to move the planter, trellis and plant from one location to another without having to remove or otherwise risk harming the growing plant. In one configuration, the trellis and planter system of the present invention incorporates components, including a tube or other water line connected to a supply of water and holes, spray nozzles or the like, that drip, spray or otherwise dispense water to the plant to allow the user to easily and effectively provide water to the plant. The trellis and planter system of the present invention is relatively inexpensive to manufacture and easy to use.

In one general aspect of the present invention, the trellis and planter system comprises an upper support member that is suspended below a support surface, a lower support member in spaced apart relation to and positioned below the upper support member, a trellis disposed between and interconnecting the upper and lower support members and a planter suspended below the lower support member. Preferably, each of the upper and lower support members and the planter are elongated and the trellis is substantially flat. The trellis can be made out of one or more wire members and substantially fill the entire space between the upper and lower support members so as to support the plants across the entire trellis. One or more support devices engage and suspend the upper support member, and therefore the system, in an easily removable manner so the system and plants can be moved without harm to the plants. One or more planter support devices position the planter below the lower support member such that the plants grow upwardly and are supported by the trellis. Water can be delivered to the upper support member so as to drip through one or more apertures in the tubular upper support member or be delivered to one or more spray devices configured to spray water onto the plants when they are supported by the trellis. The upper support member and surface support devices should be cooperatively configured so the user of the system can easily, quickly and safely remove the upper support member from the surface support devices when he or she desires to move the plants to a different location. In one embodiment, the surface support members are hooks that are configured to engage a cylindrical or tubular shaped upper support member. The trellis can be formed from a single wire member that is threaded through a plurality of eye bolts that are attached to the upper and lower support members. Alternatively, the trellis can be formed from a wire mesh or other material.

Accordingly, the primary objective of the present invention is to provide an improved plant growing system that is configured for growing a plant on a suspended trellis and planter that provides the advantages discussed above and overcomes the disadvantages and limitations associated with presently available plant growing systems.

It is also an important object of the present invention to provide an improved trellis and planter system that comprises a planter containing a plant growing medium in which grows a plant, a trellis associated with the planter over which the plant can grow and trellis support members which allows the system to be suspended below a ceiling, roof, beam or other structure with the planter being spaced above the floor, deck, patio, ground or other surface.

It is also an important object of the present invention to provide an improved trellis and planter system that comprises a planter containing a plant and a trellis associated with the planter so the plant can grow across the trellis with the components of the system being configured to be suspended from a structure and configured to be portable so the user of the system can move the planter, trellis and plant from one location to another without having to dig up or otherwise risk harm to the plant.

It is also an important object of the present invention to provide an improved trellis and planter system that, although it can be utilized with a variety of plants, is particularly configured to beneficially grow vine type of plants and allow such plants to spread across the trellis so as to improve the ornamental and/or crop bearing benefits of the plant.

It is also an important object of the present invention to provide a portable suspended trellis and planter system incorporating components that facilitate watering the plant growing from the planter and spreading out across the trellis for ease and benefit of the user when providing water to the plant.

It is also an important object of the present invention to provide a portable suspended trellis and planter system that generally utilizes conventional trellis and planter components so the system is relatively inexpensive to manufacture and easy to use.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a trellis and planter system that is configured according to a preferred embodiment of the present invention, showing the system suspended from a structure and a plant growing from the planter and across the trellis;

FIG. 2 is a front view of the trellis and planter system of FIG. 1 shown without the plant, structure and structure supports to better illustrate the present invention;

FIG. 3 is a front view of the trellis and planter system of FIG. 1 showing a possible path for a single wire trellis;

FIG. 4 is a side view of the trellis and planter system of FIG. 3;

FIG. 5 is a front view of a second embodiment of the trellis and planter system of FIG. 1 showing the use of a water line to deliver water to the system so it can be beneficially distributed to the plant;

FIG. 6 is a bottom view of the upper horizontal support of FIG. 5 with the trellis supports removed to illustrate the holes through which water can pass to drip onto the plant; and

FIG. 7 is an alternative configuration for the upper horizontal support for the trellis and planter system of the present invention showing the use of a water tube inside the upper horizontal support to deliver water to spray devices that spray water on the plant being supported by the trellis of the system.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily directed to a rectangular shaped planter, a trellis made out of wire to support the plant on the system and tubular support members, persons skilled in the art will readily understand that this is merely for purposes of simplifying the present disclosure and that the present invention is not so limited as the system of the present invention can be utilized with a variety of different configurations and materials for the planter, trellis and support members.

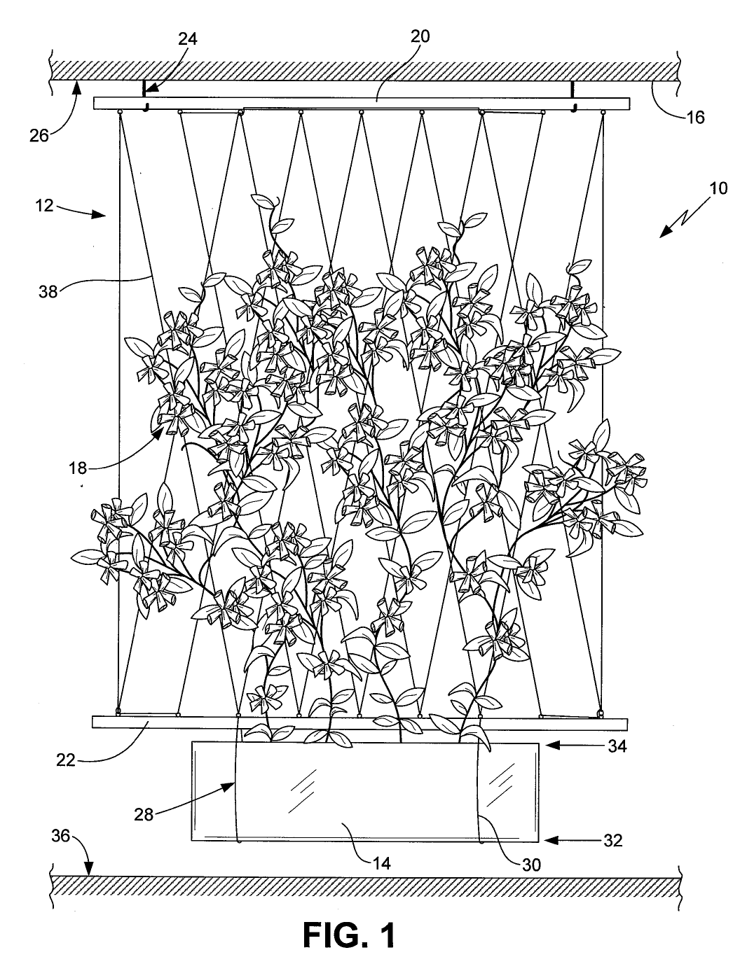

An improved trellis and planter system comprising the components of and which is configured pursuant to one embodiment of the present invention is shown generally as 10 in FIGS. 1 through 4. The trellis and planter system 10 is configured to suspend a trellis 12 and planter 14 below a support structure 16, such as a ceiling, roof, beam, cross-member or a variety of other surfaces so that one or more plants 18 can be grown in the planter 14 in a manner that allows the plants 18 to spread out across the trellis 12, as shown in FIG. 1. The system 10 further comprises an upper support member 20 and a lower support member 22, with the trellis 12 being disposed between and interconnecting the upper support member 20 and the lower support member 22. In a typical configuration, one or more surface support devices 24 will connect to and suspend the upper support member 20 below and in spaced apart relation to a support surface 26 of the support structure 16, as shown in FIG. 1. In the preferred embodiment of the present invention, in which the system 10 is portable, the one or more support devices 24 will removably support the upper support member 20 of the system 10 so the user thereof can move the trellis 12, planter 14 and plants 18 from one location to another without having to remove the plants 18 from the trellis 12 or planter 14. For instance, depending on the time of year and/or other factors, the user may desire to move the plants 18 from one end of a patio, balcony, building or other support structure 16 to the other so the plants 18 may get more or less sunlight. With the system 10 of the present invention, the user can easily, quickly and safely move the plants 18 while in the planter 14 and spread out across the trellis 12.

As shown in FIG. 1, the upper support member 20 is suspended below lower surface 26 of support structure 16 by one or more surface support devices 24. The upper support member 20 can be a variety of different sizes and configurations. In the preferred embodiment, the upper support member 20 is elongated and configured to be supported in a generally horizontal position below the lower surface 26. The upper support member 20 can be a pipe, tube or other cylindrically shaped member that is made out of a variety of materials, including plastic, metal or composite materials. Alternatively, upper support member 20 can be a square or rectangular wooden member, such as a 2x4 or the like. As set forth in more detail below, in one embodiment the upper support member 20 is a hollow tubular member selected so as to allow water to be delivered to the plants 18 through upper support member 20 or through one or more water lines that are disposed inside or otherwise associated with upper support member 20, such as being attached or otherwise secured thereto. The upper tubular member 20 and the support devices 24 should be cooperatively configured so the upper tubular member 20 can be supportedly engaged by the support devices 24 in a manner that supports the system 10 below support structure 16. In the preferred embodiment, the upper tubular member 20 and the one or more support devices 24 are cooperatively configured such that the upper tubular member 20, and as a result the system 10, is removably supported by the support devices 24. As set forth in more detail below, in this manner the user can move the system 10 from one location to another without having to remove the plants 18 from the trellis 12 and/or planter 24, which would be likely to harm or even kill the plants 18. In a preferred embodiment, the upper support member 20 is suspended in spaced apart relation to the lower surface 26 of the support structure 16, as shown in FIG. 1, for ease of removing the upper support member 20 from the support device 24 when the user desires to move system 10.

The lower support member 22 is suspended below and in spaced apart relation to the upper support member 20 by trellis 12, which interconnects the upper support member 20 and the lower support member 22, as shown in FIGS. 1 through 3. As with the upper support member 20, the lower support member 22 can be provided in a variety of different sizes and configurations. In the preferred embodiment, lower support member 22 is elongated and configured to be supported in a generally horizontal position at the bottom of trellis 12, as shown in FIGS. 1 through 3. The lower support member 22 can be a pipe, tube or other cylindrically shaped member that is made out of a variety of materials, including plastic, metal or composite materials. Alternatively, lower support member 22 can be a square or rectangular wooden member, such as a 2x4 or the like. Generally, for ease and lower cost of manufacturing, the upper support member 20 and lower support member 22 will have the same configuration, such as tubular, and be manufactured out of the same materials. If desired, the lower support member 22 can be a hollow tubular member that is also selected to allow water to be delivered to the plants 18 in the planter 24 through the interior of the lower support member 22 or through one or more water lines that are disposed inside or otherwise associated with lower support member 20, such as being attached or otherwise secured thereto.

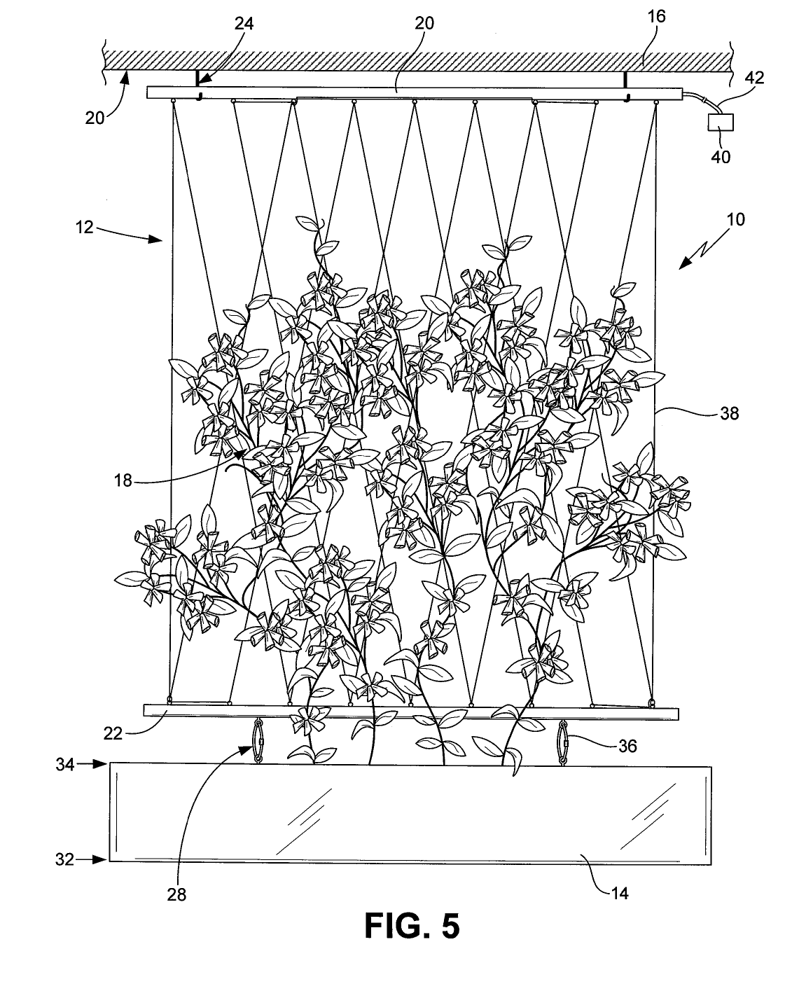

As shown in FIGS. 1 through 3, the lower support member 22 is configured to support planter 14 below lower support member 22. In a preferred embodiment, the planter 14 is suspended below the lower support member 22 by one or more planter support devices 28. As will be readily appreciated by those skilled in the art, a wide variety of planter support devices 28 can be utilized to support the planter 14 below the lower support member 22. In the embodiment shown in FIGS. 1 through 3, the planter support devices 28 are a pair of looped wire members 30 that attach to the lower support member 22 and loop around the bottom end 32 of planter 14 to suspend the planter 14 below lower support member 22. In FIG. 5, the planter support devices 28 are a pair of clips or clip like members, shown as 36 therein, that interconnect the lower support member 22 and the planter 14 to suspend planter 14 in spaced apart relation below the lower support member 22. Plants 18 planted in the planter 14 will grow upward from the planter 24 and spread across trellis 12 disposed between the upper 20 and lower 22 support members, as shown in FIG. 1. In a preferred embodiment, the planter support device(s) 28 are configured to support the planter 14 such that the top end 34 of the planter 14 is in spaced apart relation to lower support member 22 so the user can have sufficient room to work the soil or other growing medium in the planter 20 and, as necessary, perform other gardening tasks that are associated with growing plants 18, including activities such as removing weeds, trimming plants, applying nutrients and the like. As also shown in FIG. 1, in one embodiment of the system 10 of the present invention, the planter support devices 28 are also configured to support the bottom end 32 of the planter 14 in spaced apart relation to the floor, deck, patio, ground or other surface 36.

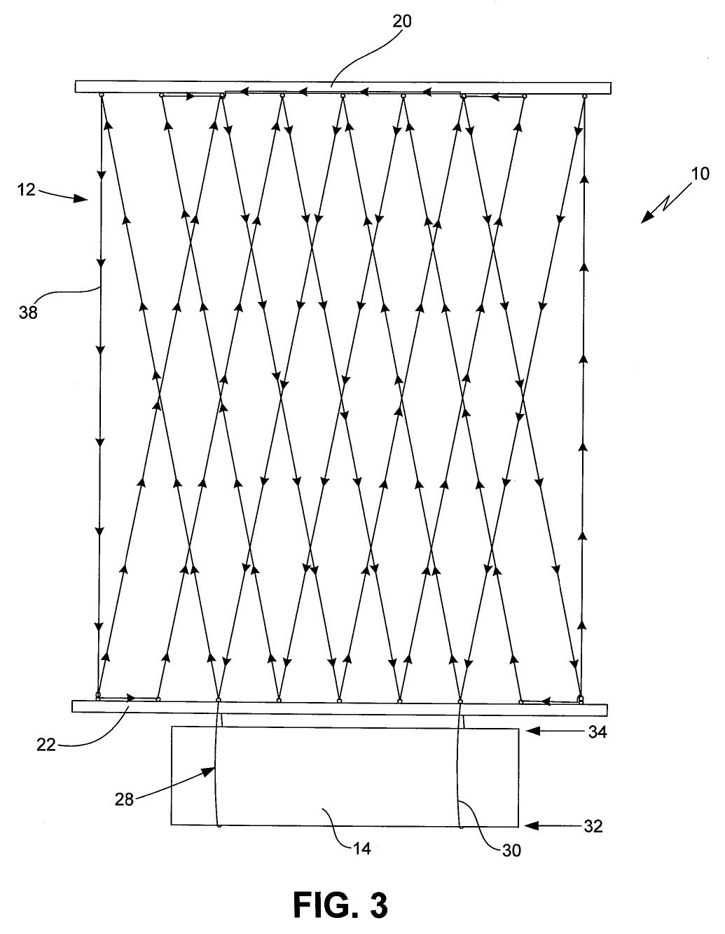

As set forth above and shown in FIGS. 1 through 3, the trellis 12 interconnects the upper support member 20 and lower support member 22 in a manner that suspends the lower support member 22 in spaced apart relation below upper support member 20. In the preferred embodiment, both the upper support member 20 and lower support member 22 are horizontally disposed and the trellis 12 fills a generally square or rectangular shaped area, as shown in FIGS. 1 through 3. Trellis 12 can be made out of a wide variety of materials and be provided in a variety of different configurations. In a preferred embodiment, the trellis 12 comprises one or more wire members 38 that are strung between the upper support member 20 and lower support member 22. The components for trellis 12, such as the wire members 38, and the configuration thereof should be selected so as to provide a sufficient structure for plants 18 to spread across and, in the case of vine plants, attach themselves to or to be attached to by the user of system 10. In one embodiment of the system 10 of the present invention, the trellis 12 is configured from one or more wire members, such as wire member 38, strung between the upper 20 and lower 22 support members by threading the wire member 38 through eye bolts or other devices attached to each of the upper 20 and lower 22 support members, as shown in FIG. 3. The wire threading pattern of FIG. 3 is one possible manner in which a single wire member 38 can be utilized to form trellis 12 into a series of angled lines that substantially fill the space between the upper 20 and lower 22 support members. In alternative embodiments, trellis 12 can be made out of wire mesh or similar materials that are formed or selected so as to substantially fill the space between upper 20 and lower 22 support members and provide sufficient area for the plants 18 to engage the trellis 12 so as to be supported thereby. As with the upper 20 and lower 22 support members, the wire member 38 or other material selected for trellis 12 is preferably selected so as to be relatively lightweight to ease in the movement of system 10, yet strong enough to support the planter 14 and plants 18.

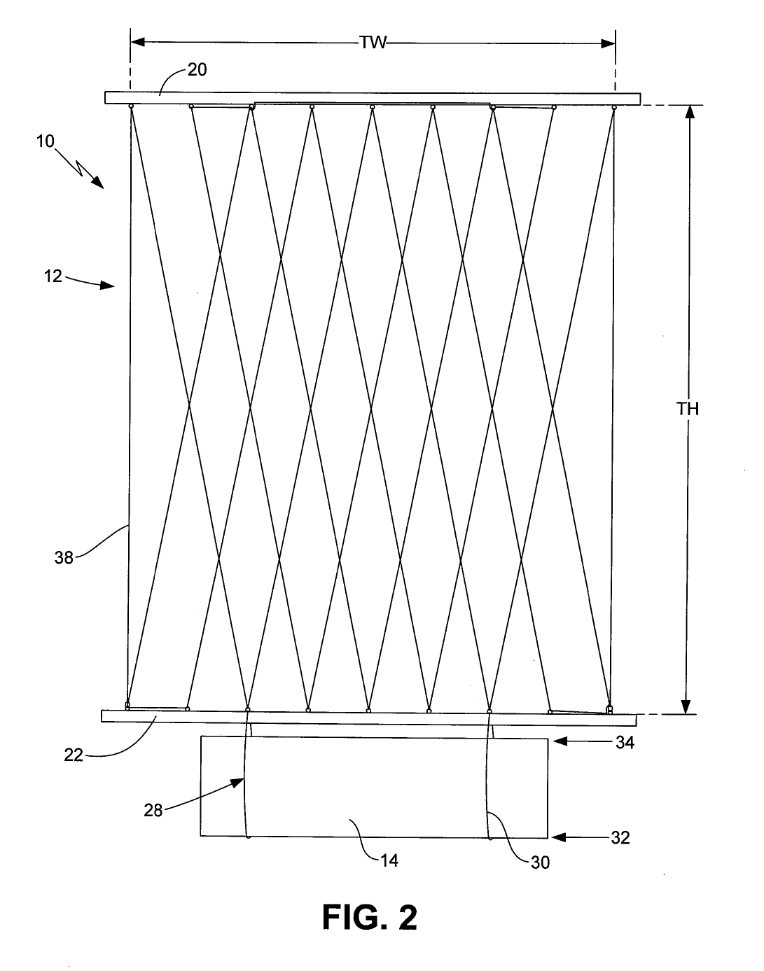

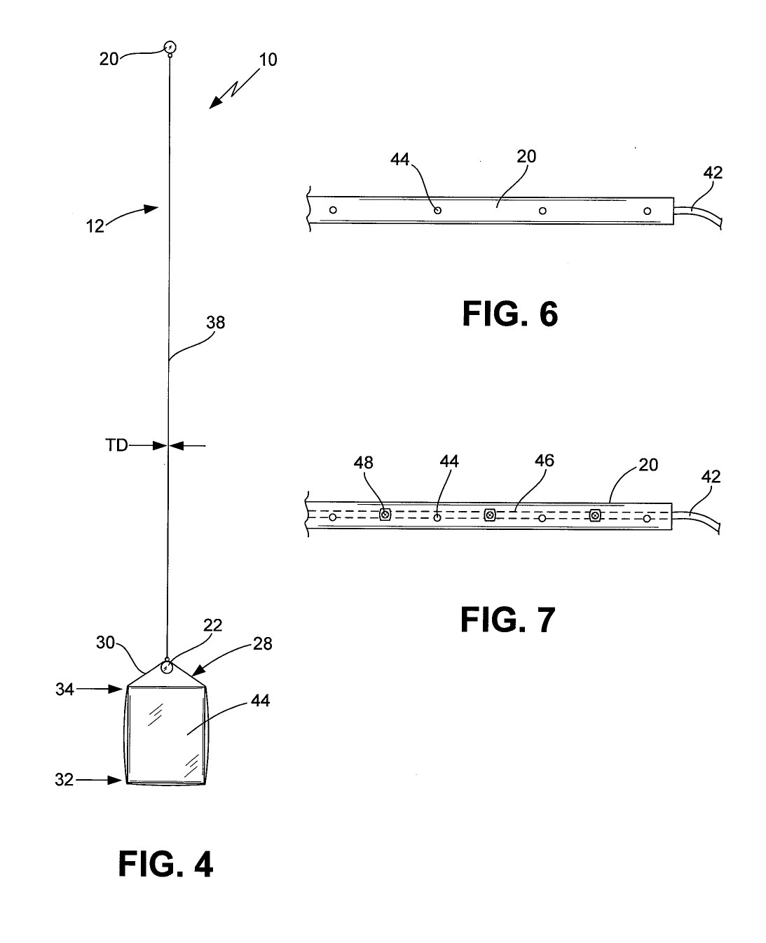

In the preferred embodiment, the trellis 12 has a trellis width TW and a trellis height TH, as shown in FIG. 2, that is sufficiently wide and high to fill the area between upper 20 and lower 22 support members and beneficially support the plants 18 as they grow upward and across trellis 12. As an example, trellis width TW can be four to eight feet and the trellis height can be four to five feet. These measurements are provided merely for exemplary purposes and are not intended to limit the dimensions of the present invention in any manner. In the preferred embodiment, the trellis 12 is provided with a generally flat shape with the trellis width TW being significantly greater than the trellis depth TD of trellis 12, as shown in FIG. 4. In one embodiment, the trellis depth TD is one to three inches or less. The flat configuration of trellis 12 will provide a better shaped support surface for the plants 18 and make it easier for the user to move the system 10 from one location to another.

As set forth above, the planter 14 is suspended below and supported by the lower support member 22 such that it is positioned below the trellis 12 so plants 18 will grow upward from planter 14 and engage the trellis 12. The planter 14 can have a variety of different shapes and configurations. In the preferred embodiment, however, planter 14 is elongated, unlike prior art growing systems that use plant pots and the like, so as to at least somewhat extend the trellis width TW of the trellis 12. In one embodiment, planter 14 has an elongated rectangular shape with a length of four to six feet with a width and height of approximately twelve to eighteen inches. The above shape and measurements are provided merely for exemplary purposes and are not intended to limit the dimensions of the planter 14 of the present invention in any manner, as the planter 14 can be of virtually any size and made into a generally square, oval or other shape. Planter 14 can be made out of wood, plastic, ceramic, metal and a variety of other materials or combinations of various materials, as are commonly utilized for planters and the like. As will be readily appreciated by those skilled in the art, the planter 14 needs to be sized and configured to hold the planting medium in which the plants 18 grow and support the plants 18 as they grow. Planter 14 must be of sufficient strength to support the weight of the plants 18, planting medium and the quantity of water expected to be in the planting medium at any given time. The upper support member 20, trellis 12 and lower support member 22, as well as the various support devices 24/28 and their respective connections, must also be of sufficient strength to support the weight of a water-logged planter 14 and the plants 18 therein.

In one configuration of the system 10 of the present invention, the system 10 comprises a supply of water 40 that connects to the upper support member 20 by one or more water lines 42, as shown in FIGS. 5 through 7. The water line 42 can deliver water from the supply of water 40 to the upper support member 20 in a manner that can beneficially disperse that water to the plants 18 on the trellis 12 and in planter 14 to assist the user with watering plants 18. In one embodiment, the water line 42 delivers water to the interior of the tubular upper support member 20 so that the water can drip down from the upper support member 20 through one or more apertures 44 in the upper support member 20, as shown in FIG. 6, along the wire members 38 of trellis 12. Alternatively, the water line 42 can extend inside tubular lower support member 22 or be attached to the outside of or otherwise associated with the lower support member 22. In another embodiment, the water line 42 can connect to one or more tubes 46 disposed inside, attached to or otherwise associated with upper support member 20 so as to deliver water to one or more spray devices 48, as shown in FIG. 7. The spray devices 48 can be positioned on upper support member 20 so as to spray water therefrom in a generally downward direction to spray water onto the plants 18 supported by trellis 12. Water not taken up by leaves or vines of plants 18 can drip or otherwise flow down into planter 14 to be utilized by plants 18.

In use, the user will attach the system 10 of the present invention to support structure 16 by using on or more support devices 24, which will typically extend downward from the support surface 26 of support structure 16. The support devices 24 can be hooks, as shown, or a wide variety of different types of devices that are capable of supporting, preferably removably, the system 10 by connecting to the upper support member 20. With the system 10 suspended below the support structure 16, the weight of planter 14 will extend the trellis 12 to its full trellis length TL. Planter 14 is then filled with the desired plant medium, such as soil or the like, and the plants 18 are planted in the planter 14 so they can begin to grow therefrom. The plants 18 will grow upward and engage the trellis 12 so as to be supported generally vertically thereby, as shown in FIGS. 1 and 5. With the upper support member 20 in spaced apart relation to the support surface 26 of support structure 16, the user can easily grasp the upper support member 20 when he or she desires to move the system 10 to a new location. With the top end 34 of the planter 14 in spaced apart relation to lower support member 22, the user will have room to work on the plants 18 and/or the soil or other growing medium in planter 14. When the user does decide to move the plants 18 to a different location, he or she can move the entire system 10 as a single unit, thereby eliminating the need to remove the plants 18 from planter 14 and/or disconnect the plants 18 from the trellis 12. Instead, he or she merely needs to grasp the upper support member 20, disengage it from the support devices 24 (such as the hooks shown), move the entire system 10 to a new location and then place the upper support member 20 on the support devices 24 at the new location.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A trellis and planter system for one or more plants, said system comprising:
an upper support member configured to be supportedly disposed below a support surface by one or more surface support devices interconnecting said support surface and said upper support member;
a lower support member disposed below and in spaced apart relation to said upper support member;
a trellis interconnecting said upper support member and said lower support member;
a planter configured to receive and support said one more plants; and
one or more planter support devices interconnecting said lower support member and said planter for supporting said planter generally below said lower support member when said upper support member is disposed below said support surface.

2. The trellis and planter system of claim 1, wherein each of said upper support member and said lower support member are elongated.

3. The trellis and planter system of claim 1, wherein said upper support member is configured to be connected to a supply of water by one or more water lines.

4. The trellis and planter system of claim 3, wherein said upper support member is tubular and said one or more water lines are configured to deliver water from said source of water inside said upper support member so as to disperse water through one or more apertures in said upper support member.

5. The trellis and planter system of claim 4, wherein said one or more apertures are configured to drip water to said planter along said trellis.

6. The trellis and planter system of claim 3, wherein said one or more water lines are configured to deliver water from said water source to one or more spray devices associated with said upper support member so as to spray water towards said trellis.

7. The trellis and planter system of claim 1, wherein said planter is elongated.

8. The trellis and planter system of claim 1, wherein said trellis has a trellis width that is significantly larger than a trellis depth of said trellis such that said trellis is substantially flat.

9. The trellis and planter system of claim 1, wherein said trellis is made up of a single elongated member.

10. The trellis and planter system of claim 9, wherein said wire member forms said trellis so as to provide support for the plants substantially between said upper support member and said lower support member.

11. A trellis and planter system for one or more plants, said system comprising:
an elongated upper support member configured to be supportedly disposed below a support surface by one or more surface support devices interconnecting said support surface and said upper support member;
an elongated lower support member disposed below and in spaced apart relation to said upper support member;
a substantially flat trellis interconnecting said upper support member and said lower support member, said trellis having a trellis width significantly larger than a trellis depth thereof;
an elongated planter configured to receive and support said one more plants; and
one or more planter support devices interconnecting said lower support member and said planter for supporting said planter generally below said lower support member when said upper support member is disposed below said support surface.

12. The trellis and planter system of claim 11, wherein said upper support member is configured to be connected to a supply of water by one or more water lines.

13. The trellis and planter system of claim 12, wherein said upper support member is tubular and said one or more water lines are configured to deliver water from said source of water inside said upper support member so as to disperse water through one or more apertures in said upper support member, said one or more apertures configured to drip water to said planter along said trellis.

14. The trellis and planter system of claim 12, wherein said one or more water lines are configured to deliver water from said water source to one or more spray devices associated with said upper support member so as to spray water towards on the plants when supported on said trellis.

15. The trellis and planter system of claim 11, wherein said trellis is made up of a single elongated member.

16. The trellis and planter system of claim 15, wherein said wire member forms said trellis so as to provide support for the plants substantially between said upper support member and said lower support member.

17. A trellis and planter system for one or more plants, said system comprising:
an elongated horizontally disposed upper support member removably suspended below a support surface by one or more surface support devices, each of said surface support devices configured to interconnect said support surface and said upper support member;
an elongated lower support member disposed generally horizontally below and in spaced apart relation to said upper support member;
a substantially flat trellis interconnecting said upper support member and said lower support member, said trellis having a trellis width significantly larger than a trellis depth thereof;
an elongated planter configured to receive and support said one more plants; and
a planter support means interconnecting said lower support member and said trellis for supporting said planter below and in spaced apart relation to said lower support member.

18. The trellis and planter system of claim 17, wherein said upper support member is configured to be connected to a supply of water by one or more water lines.

19. The trellis and planter system of claim 18, wherein said upper support member is tubular and said one or more water lines are configured to deliver water from said source of water inside said upper support member so as to disperse water through one or more apertures in said upper support member, said one or more apertures configured to drip water to said planter along said trellis.

20. The trellis and planter system of claim 18, wherein said one or more water lines are configured to deliver water from said water source to one or more spray devices associated with said upper support member so as to spray water towards on the plants when supported on said trellis.
